(19) United States
(12) Patent Application Publication
(10) Pub. No.: US 2006/0250566 A1
(43) Pub. Date: Nov. 9, 2006

(54) Liquid crystal display

(76) Inventors: Hyun-wuk Kim, Yongin-si (KR); Jae-jin Lyu, Yongin-si (KR); Hak-sun Chang, Yongin-si (KR); Hee-wook Do, Suwon-si (KR)

Correspondence Address: CANTOR COLBURN, LLP, 55 GRIFFIN ROAD SOUTH, BLOOMFIELD, CT, 06002, US

(21) Appl. No.: 11/418,280

(22) Filed: May 4, 2006

(30) Foreign Application Priority Data
May 4, 2005 (KR) 10-2005-0037665

(51) Int. Cl. C09K 19/52

(52) U.S. Cl. 349/164

(57) ABSTRACT

Provided is a liquid crystal display with an enhanced structure using liquid crystals containing an emission material. The liquid crystals of the liquid crystal display include fluorescent substances absorbing ultraviolet light and then emitting visible light. In a liquid crystal display forming a vertical electric field, the liquid crystal display includes a backlight unit having a light source emitting ultraviolet light, and a display unit including a first plate having a plurality of pixel electrodes, a second plate opposite to the first plate and having a common electrode forming a vertical electric field through its interaction with the pixel electrodes, and a liquid crystal layer interposed between the first plate and the second plate and having fluorescent substances absorbing the ultraviolet light emitted from the backlight unit and emitting red, green, or blue light. A liquid crystal display forming a horizontal electric field is also provided.

This application claims priority to Korean Patent Application No. 10-2005-0037665, filed on May 4, 2005 and all the benefits accruing therefrom under 35 U.S.C. §119, and the contents of which in its entirety are herein incorporated by reference.

### BACKGROUND OF THE INVENTION

1. Field of the Invention

The present invention relates to a liquid crystal display, and more particularly, to a liquid crystal display with an enhanced structure with improved transmittance and viewing angle.

2. Description of the Related Art

As the modern industrial society steps into the high information era, electronic displays are regarded as being increasingly important, and various types of electronic display devices have been widely applied in a wide variety of industrial fields.

As semiconductor technology continues to evolve, a continuing trend is towards a low drive voltage, low power consumption, compactness, and lightweight structure with a variety of electronic display devices. Accordingly, electronic display devices adapted to new environments, that is, light, thin, small flat panel displays are of interest due to their various advantages, having a low voltage drivability, low power consumption, small size, and lightweight structure, and are increasingly demanded.

Among currently known flat panel display devices, the liquid crystal display (“LCD”) offers various outstanding features, including thinness, lightweight structure, low power consumption, and low voltage drivability, compared to other display devices. Furthermore, since LCDs can offer substantially the same level of image quality as cathode ray tubes (“CRTs”), they can be widely applied in various electronic devices.

Generally, LCDs include a backlight unit emitting light and a display unit displaying an image using the light emitted from the backlight unit. Polarization films are disposed on upper and lower surfaces of the display unit. The polarization film allows only light beams that violently vibrate in a predetermined direction among light beams transmitted through liquid crystals to selectively pass therethrough. By doing so, the display unit can implement its intrinsic function of displaying an image.

However, the transmittance of light emitted from a backlight unit of LCDs is about 45% in upper and lower polarization films, about 65% in a first plate, and about 27% in a second plate. Accordingly, the total light transmittance of a display unit is about 7.9%. Furthermore, LCDs have the structure where a second plate and polarization films allow only a light beam having a predetermined color and orientation to pass therethrough. Light passed through the second plate and the polarization films travels straight in a predetermined direction, thereby leading to a narrow viewing angle.

### BRIEF SUMMARY OF THE INVENTION

The present invention provides a liquid crystal display (“LCD”) with improved transmittance and viewing angle using liquid crystals containing an emission material.

The present invention also provides an LCD with no additional increase in manufacturing costs and power consumption.

According to exemplary embodiments of the present invention, there is provided an LCD including a backlight unit having a light source emitting ultraviolet light, and a display unit including a first plate having a plurality of pixel electrodes, a second plate opposite to the first plate and having a common electrode forming a vertical electric field through its interaction with the pixel electrodes, and a liquid crystal layer interposed between the first plate and the second plate and having fluorescent substances absorbing the ultraviolet light emitted from the backlight unit and emitting red, green, or blue light.

According to other exemplary embodiments of the present invention, there is provided an LCD including a backlight unit having a light source emitting ultraviolet light, and a display unit including a first plate having a plurality of pixel electrodes and common electrodes formed alternately parallel to each other on the first plate and forming a horizontal electric field through interaction therebetween, a second plate opposite to the first plate, and a liquid crystal layer interposed between the first plate and the second plate and having fluorescent substances absorbing the ultraviolet light emitted from the backlight unit and emitting red, green, or blue light.

According to still other exemplary embodiments of the present invention, there is provided an LCD including a liquid crystal layer including liquid crystals, first fluorescent substances emitting a first colored light, second fluorescent substances emitting a second colored light differently colored from the first colored light, and third fluorescent substances emitting a third colored light differently colored from the first and second colored lights.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic sectional view illustrating an exemplary embodiment of an LCD according to the present invention;

FIGS. 2 and 3 illustrate an exemplary liquid crystal layer constituting an exemplary embodiment of an LCD according to the present invention;

FIG. 4 schematically illustrates an exemplary operation of an exemplary embodiment of an LCD according to the present invention in a voltage-off state;

FIG. 5 schematically illustrates an exemplary operation of an exemplary embodiment of an LCD according to the present invention in a voltage-on state;

FIG. 6 is a schematic sectional view illustrating another exemplary embodiment of an LCD according to the present invention;

FIGS. 7 and 8 are schematic perspective views illustrating still other exemplary embodiments of LCDs according to the present invention;

FIG. 9 is a schematic sectional view illustrating yet another exemplary embodiment of an LCD according to the present invention;

FIG. 10 schematically illustrates an exemplary operation of the exemplary embodiments of the LCD shown in FIG. 9 in a voltage-off state;

FIG. 11 schematically illustrates an exemplary operation of the exemplary embodiments of the LCD shown in FIG. 9 in a voltage-on state;

FIG. 12 is a schematic sectional view illustrating a further exemplary embodiment of an LCD according to the present invention; and

FIGS. 13 and 14 are schematic perspective views illustrating other exemplary embodiments of LCDs according to the present invention.

### DETAILED DESCRIPTION OF THE INVENTION

The invention will now be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

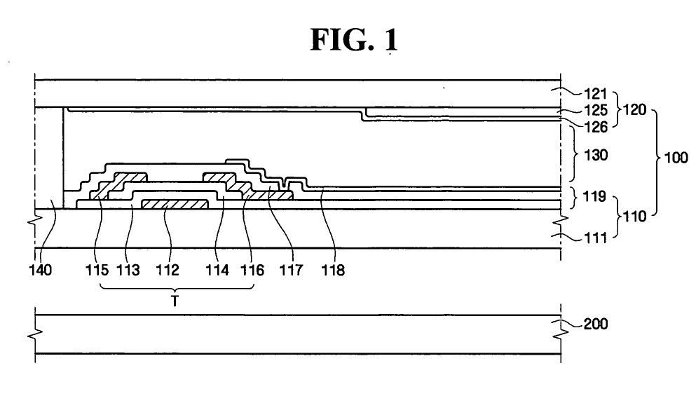

Exemplary embodiments of liquid crystal displays (“LCDs”) forming a vertical electric field according to the present invention will now be described more fully with reference to FIGS. 1 through 8.

FIG. 1 is a schematic sectional view illustrating an exemplary embodiment of an LCD according to the present invention.

Referring to FIG. 1 illustrating an LCD forming a vertical electric field, the LCD includes a display unit 100 displaying an image using light and a backlight unit 200 supplying light to the display unit 100.

The display unit 100 includes a first plate 110 having thin film transistors (“TFTs”) T, a second plate 120 oppositely joined to the first plate 110, a liquid crystal layer 130 interposed between the first plate 110 and the second plate 120 and including liquid crystals and fluorescent substances, as will be further described below, and a sealant 140 joining the first plate 110 and the second plate 120.

The first plate 110 includes a transparent substrate 111, made of glass, plastic, or the like, and an array layer 119 formed on the transparent substrate 111 and having a matrix-type array of the TFTs used as switching devices.

The array layer 119 includes data and gate lines (not shown) carrying data and gate signals, a pixel electrode 118 made of conductive oxide such as, but not limited to, transparent conductive material such as indium tin oxide (“ITO”), and TFTs T connected to the data and gate lines and applying a signal voltage to the pixel electrode 118 or preventing the signal voltage from reaching the pixel electrode 118. Here, each TFT T includes a gate electrode 112, a gate insulating layer 113, a semiconductor layer 114 made of an amorphous silicon (“a-Si”) material, and source/drain electrodes 115 and 116. Reference numeral 117 refers to an inter-insulating layer.

A source side tape carrier package (“TCP”, not shown) on which a driving circuit for applying a data side driving signal to the data lines is mounted or otherwise attached to the source side of the first plate 110, and a gate side TCP (not shown) on which a driving circuit for applying a gate side driving signal to the gate line is mounted or otherwise attached to the gate side of the first plate 110.

The second plate 120 includes a transparent substrate 121, made of glass, plastic, or the like, a color filter layer 125 formed on the transparent substrate 121 and creating a color image by light, and a common electrode 126. The common electrode 126 may cover an entire surface, or substantially an entire surface, of the second plate 120 and faces the pixel electrodes 118.

The color filter layer 125, formed by a thin film process, includes a plurality of color pixels (not shown) creating color images using light emitted from the backlight unit 200 and a black matrix (not shown) blocking leakage light from the plurality of the color pixels to enhance a contrast ratio.

The plurality of the color pixels are composed of red, green, and blue (“RGB”) color pixels. Each of the RGB color pixels is positioned in each pixel area which is an image display unit. The RGB color pixels are formed using photoresist containing RGB pigments or dyes. The RGB color pixels are arranged in a predetermined pattern according to a color array standard for image display. At this time, the RGB color pixels have a thickness of about 1.0 to 2.0 μm. While RGB color pixels are employed in the exemplary embodiments of the LCDs described herein, it would be within the scope of these embodiments to use alternate colors.

The black matrix separately surrounds each of the RGB color pixels, and blocks leakage light from the RGB color pixels. The black matrix is disposed opposite to each TFT T formed in the first plate 110 so that the TFTs T are not recognized from outside the display unit 100. The black matrix may be made of chromium (Cr) or photoresist in which a carbon black pigment or a mixed pigment of red, green, and blue pigments is dispersed. Other materials for forming the black matrix would also be within the scope of these embodiments.

The common electrode 126 formed on the color filter layer 125 serves as one electrode applying a voltage to liquid crystals within the liquid crystal layer 130, and forms a vertical electric field through its interaction with the pixel electrodes 118 formed in the first plate 110.

Meanwhile, the liquid crystal layer 130 interposed between the first plate 110 and the second plate 120 includes liquid crystals and fluorescent substances.

The liquid crystals are organic compounds exhibiting intermediate properties between liquids and crystals within a predetermined temperature range, and may undergo a change in color, transparency, and molecular orientation according to voltage, temperature, etc. The types of the liquid crystals that can be used herein may be smectic, nematic, and cholesteric. However, the present invention is not limited thereto.

The fluorescent substances contained in the liquid crystal layer 130 are materials absorbing ultraviolet (“UV”) light and emitting visible light. The fluorescent substances can be easily rearranged according to an external voltage due to their anisotropy. The fluorescent substances can be divided into red, green, and blue fluorescent substances according to the color of the visible light.

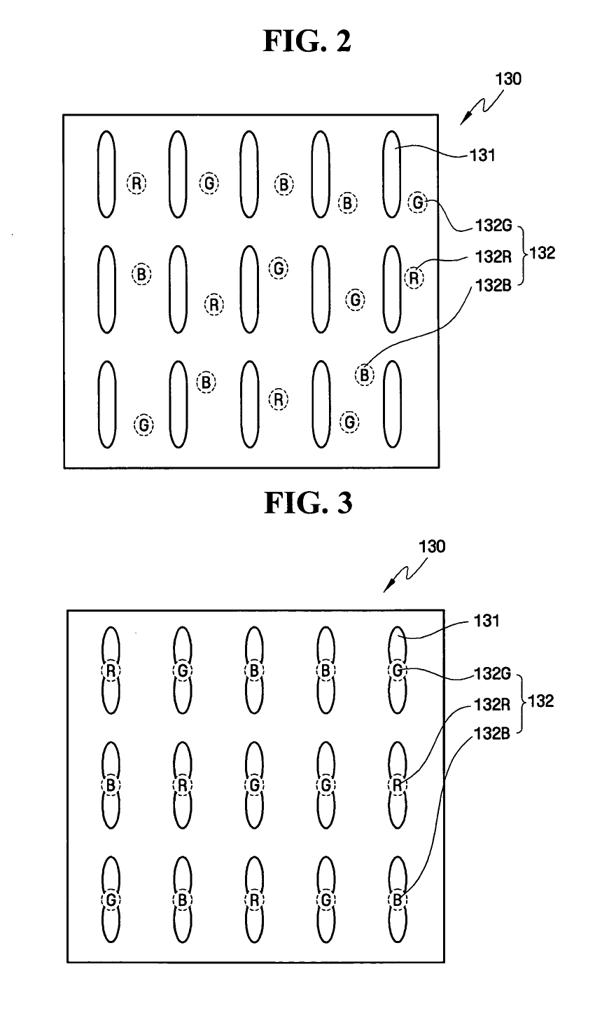

FIGS. 2 and 3 illustrate an exemplary liquid crystal layer constituting an exemplary embodiment of an LCD according to the present invention.

Referring to FIGS. 2 and 3, fluorescent substances 132 composed of red, green, and blue fluorescent substances 132R, 132G, and 132B may be in a mixed state with liquid crystals 131 in a liquid crystal layer 130 (FIG. 2) or in a combined state with the liquid crystals 131 (FIG. 3). The behavior of the liquid crystals 131 and the fluorescent substances 132 in the liquid crystal layer 130 in connection with gray scale control according to voltage application will be further described below. For example, in a mixed state between the fluorescent substances 132 and the liquid crystals 131 as shown in FIG. 2, the fluorescent substances 132 are aligned in substantially the same direction as the liquid crystals 131 according to the direction of electric field because they have substantially the same anisotropy as the liquid crystals 131. In a combined state between the fluorescent substances 132 and the liquid crystals 131 as shown in FIG. 3, the fluorescent substances 132 are aligned together with the liquid crystals 131 in the same direction as the orientation of the liquid crystals 131 according to the direction of electric field.

To insert the liquid crystal layer 130 into a gap between the first plate 110 and the second plate 120, the sealant 140 is interposed between the first plate 110 and the second plate 120.

The sealant 140 joins the first plate 110 and the second plate 120 which are in a separate state by a predetermined distance to ensure a space for forming the liquid crystal layer 130. For example, the sealant 140 may be provided along a periphery of the first and second plates 110 and 120 for enclosing the liquid crystal layer 130 therein. At this time, the data lines and the gate lines of the array layer 119 are exposed to be electrically connected to the data side TCP and the gate side TCP, respectively.

When the backlight unit 200 is a direct type backlight unit in which a light source is disposed on a rear part of the display unit 100, it may include a reflective sheet and a diffusion sheet. When the backlight unit 200 is an edge type backlight unit in which a light source is disposed on a side or a plurality of sides of the display unit 100, it may further include a light guide plate.

The light source is used to supply light to the display unit 100 and may be a UV light source. In the case of using a vertical electric field like in this embodiment, the UV light source may be a polarized UV light source or an unpolarized UV light source. UV light emitted from the UV light source collides with the red, green, and blue fluorescent substances 132R, 132G, and 132B of the liquid crystal layer 130, thereby emitting visible light, as will be further described below in the operation of an LCD. The wavelength (λ) of the UV light emitted from the UV light source may be in the range from 200 to 400 nm, for example from 380 to 400 nm. The type of the UV light source may be diversely selected according to the use purpose of an LCD.

When the backlight unit 200 is a direct type backlight unit, the reflective sheet is positioned at a lower portion of the light source, and allows light emitted from the lower portion of the light source to be directed toward an upper portion of the light source. To enhance the reflectivity of the reflective sheet, a basic material such as steel use stainless (SUS), brass, aluminum, or polyethyleneterephthalate (PET) may be coated with silver. Even when heat is slightly generated, titanium coating can be included to prevent device deformation due to heat absorption for a long time. However, the present invention is not limited thereto.

The diffusion sheet serves to uniformly diffuse and collect light emitted from the light source, thereby accomplishing brightness uniformity. The diffusion sheet may include sphere shapes using a polyesterterephthalate-based acrylic resin, but is not limited thereto.

The light guide plate allows light emitted from an edge type light source to uniformly pass through the entire area of the display unit 100. The light guide plate may be made of a material which has high strength and light transmittance and is not easily broken or deformed. For example, a transparent acrylic resin may be used but the present invention is not limited thereto.

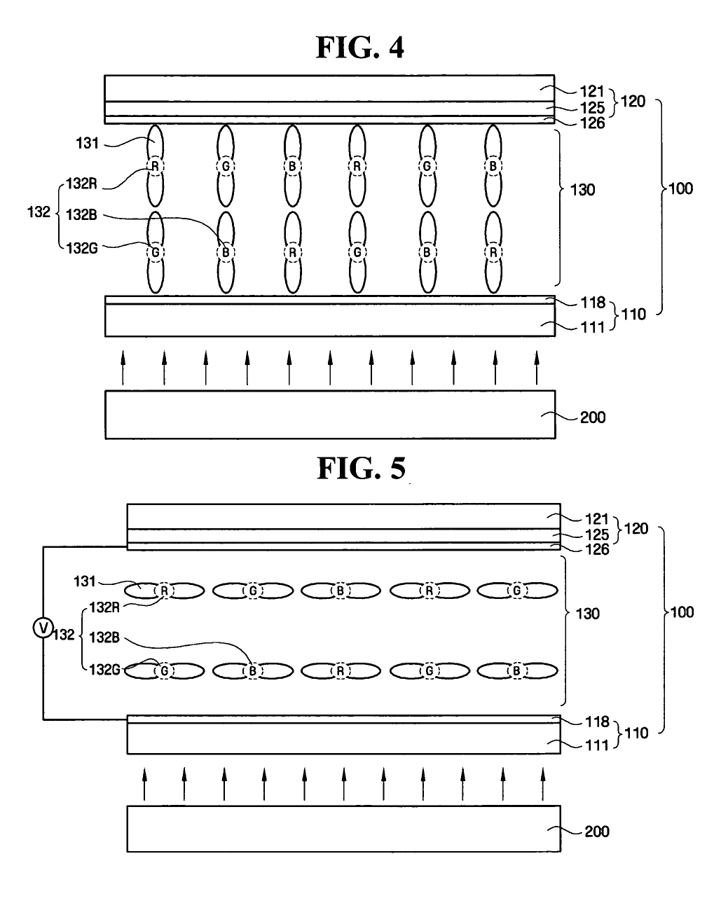

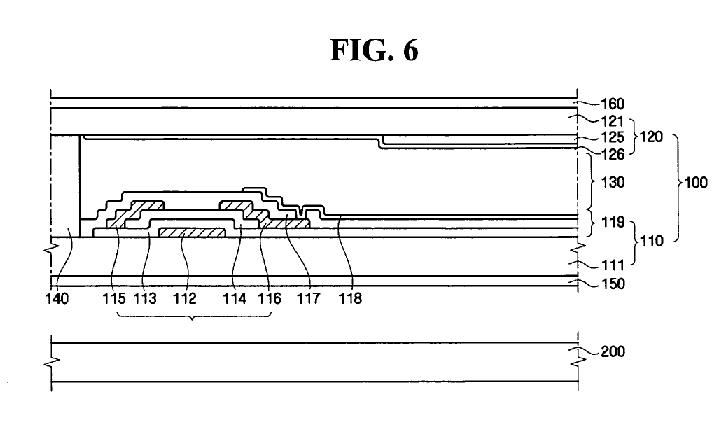

Hereinafter, an exemplary operation of an exemplary embodiment of an LCD according to the present invention will be described with reference to FIGS. 4 and 5.

FIG. 4 schematically illustrates an exemplary operation of an exemplary embodiment of an LCD according to the present invention in a voltage-off state and FIG. 5 schematically illustrates an exemplary operation of an exemplary embodiment of an LCD according to the present invention in a voltage-on state. For convenience of illustration, an operation of an exemplary embodiment of an LCD including a liquid crystal layer in which liquid crystals vertically oriented in a voltage-off state are combined with red, green, and blue fluorescent substances as shown in FIG. 3 will be described. However, the present invention is not limited thereto, and may instead include a liquid crystal layer in which liquid crystals vertically oriented in a voltage-off state are mixed with red, green, and blue fluorescent substances as shown in FIG. 2.

First, an operation of an LCD in a voltage-off state will be described.

Referring to FIG. 4, UV light emitted from a backlight unit 200 including a UV light source passes through a display unit 100 in a substantially perpendicular direction to first and second plates 110 and 120 of the display unit 100.

At this time, major axes of liquid crystals 131 of a liquid crystal layer 130 are oriented parallel to the UV light-traveling direction, and fluorescent substances 132 composed of red, green, and blue fluorescent substances 132R, 132G, and 132B in combination with the liquid crystals 131 are also oriented substantially parallel to the UV light-traveling direction. That is, the UV light passing through the display unit 100 is substantially parallel to the orientation of the red, green, and blue fluorescent substances 132R, 132G, and 132B. Therefore, collision between the UV light and the fluorescent substances 132 hardly occurs, thereby leading to a black mode of an LCD.

Next, an operation of an LCD in a voltage-on state will be described.

Referring to FIG. 5, a voltage is applied to pixel electrodes 118 formed in a first plate 110 including TFTs (as shown in FIG. 1) and a common electrode 126 formed in a second plate 120 including a color filter layer 125 so that a sufficient voltage above a critical voltage is applied to a liquid crystal layer 130. FIG. 5 illustrates the case where, in a voltage-on state, the major axes of liquid crystals 131 are oriented in a substantially perpendicular direction to a UV light-traveling direction. At this time, fluorescent substances 132 composed of red, green, and blue fluorescent substances 132R, 132G, and 132B in combination with the liquid crystals 131 are also oriented in a substantially perpendicular direction to the UV light-traveling direction. Therefore, UV light emitted from a backlight unit 200 collides with the red, green, and blue fluorescent substances 132R, 132G, and 132B oriented in a substantially perpendicular direction to the UV light-traveling direction. In this case, a collision area of the fluorescent substances 132 with the UV light is relatively increased, thereby emitting much visible light, as compared to when the fluorescent substances 132 are oriented substantially parallel to the UV light-traveling direction, as previously described with respect to FIG. 4. Voltage application to the liquid crystal layer 130 as shown in FIG. 5 gives rise to a white mode of an LCD. Thus, adjustment of the voltage difference between the pixel electrodes 118 and the common electrode 126 enables gray scale control. That is, in a case where the fluorescent substances 132 of the liquid crystal layer 130 are in a predetermined ratio, e.g., in a case where the red, green, and blue fluorescent substances 132R, 132G, and 132B are in the same ratio, a collision area of the fluorescent substances 132 with UV light emitted from a light source can be adjusted by changing the orientation of the liquid crystals 131 and the red, green, and blue fluorescent substances 132R, 132G, and 132B corresponding to respective pixel areas along a vertical electric field formed due to a voltage difference between a predetermined voltage applied to each pixel electrode 118 through turn-on/off switching of the TFT T of each pixel and a predetermined voltage applied to the common electrode 126, which enables gray scale control.

As described above, grayscale-calibrated light beams create desired color images while passing through the second plate 120. That is, RGB color pixels formed in the color filter layer 125 of the second plate 120 allow only red, green, and blue light beams to pass therethrough according to the characteristics of the color pixels, thereby creating color images that can be perceived by a viewer.

The LCD according to the above-described embodiment has the structure which includes a UV light source and a liquid crystal layer 130 including liquid crystals 131 and fluorescent substances 132. The orientation of the liquid crystals 131 and the fluorescent substances 132 is changed according to a voltage-on/off state, thereby enabling gray scale control. Therefore, no polarization films are separately required at the outermost sides of the display unit 100, thereby preventing reduction in transmittance and viewing angle due to polarization films.

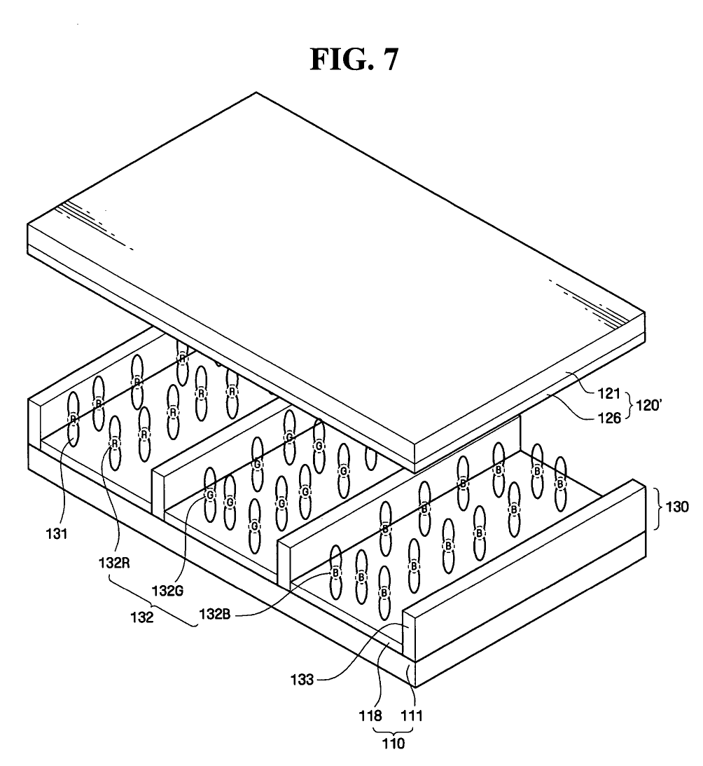

Hereinafter, another exemplary embodiment of an LCD forming a vertical electric field according to the present invention will be described with reference to FIG. 6. The exemplary embodiment of the LCD shown in FIG. 6 is substantially the same as that of the previous embodiment except that a polarization film is formed on a surface of a first plate or a second plate opposite to a liquid crystal layer. Thus, a detailed description of overlapping portions will be omitted for convenience of illustration.

FIG. 6 is a schematic sectional view illustrating another exemplary embodiment of an LCD according to the present invention.

Referring to FIG. 6, the LCD includes a polarization film 150 formed on one of the two outermost surfaces of a display unit 100 displaying an image using light, e.g., on a surface of a first plate 110 opposite to a liquid crystal layer 130. That is, while the liquid crystal layer 130 is formed on an inner surface of the first plate 110, the polarization film 150 may be formed on an outer surface of the first plate 110.

The polarization film 150 is used to enhance a contrast ratio of the LCD. That is, the polarization film 150 can polarize UV light so that, in a voltage-on state, the orientation of the major axes of liquid crystals (see 131 of FIG. 2) and fluorescent substances (see 132 of FIG. 2 or 3) of the liquid crystal layer 130 is parallel to the polarization direction of the UV light. Therefore, the collision area of the fluorescent substances with the UV light increases, thereby maximizing a white level. Accordingly, the contrast ratio before and after voltage application can be enhanced.

An antireflective layer 160 may be further formed on a surface of a second plate 120 opposite to the liquid crystal layer 130 to prevent the incidence of light passed through the display unit 100 back into the display unit 100. That is, while the liquid crystal layer 130 is formed on an inner surface of the second plate 120, the antireflective layer 160 may be formed on an outer surface of the second plate 120.

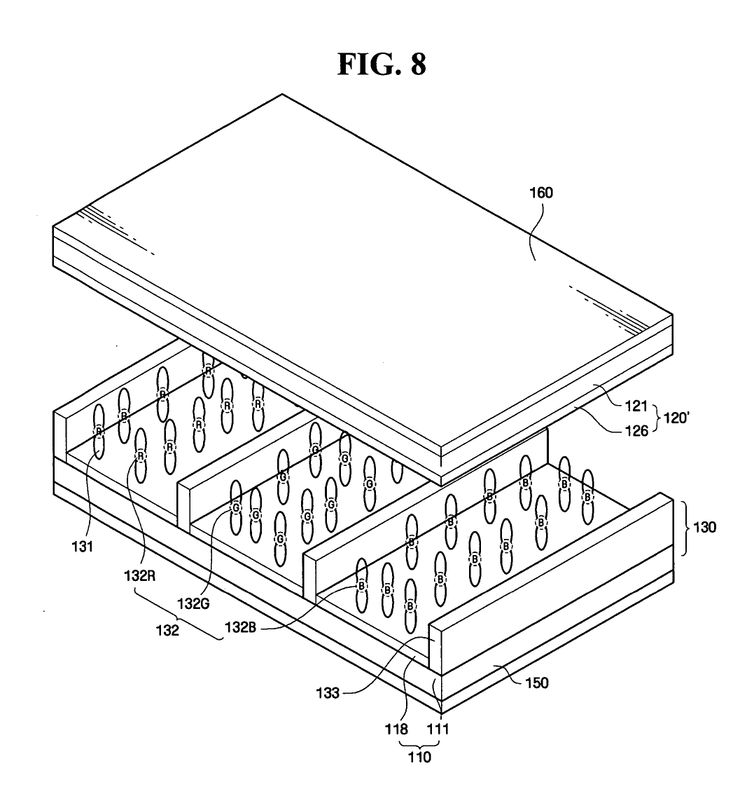

Hereinafter, still another exemplary embodiment of an LCD forming a vertical electric field according to the present invention will be described with reference to FIG. 7. The exemplary embodiment of the LCD shown in FIG. 7 is substantially the same as that of the exemplary embodiment of the LCD shown in FIG. 1 except that a liquid crystal layer is divided by a barrier rib according to the color of fluorescent substances, and thus a detailed description of overlapping portions will be omitted for convenience of illustration.

FIG. 7 is schematic perspective view illustrating still other exemplary embodiments of LCDs according to the present invention.

Referring to FIG. 7, in a liquid crystal layer 130 constituting a display unit of an LCD, liquid crystals 131 containing red fluorescent substances 132R, liquid crystals 131 containing green fluorescent substances 132G, and liquid crystals 131 containing blue fluorescent substances 132B are partitioned by barrier ribs 133 in such a way to correspond to respective pixel areas. At this time, the liquid crystals 131 and the red, green, and blue fluorescent substances 132R, 132G, and 132B contained in the liquid crystal layer 130 may be in a mixed state as shown in FIG. 2 or in a combined state as shown in FIG. 3.

The barrier ribs 133 may be spaced a predetermined distance apart from each other and are positioned between the first plate 110 and the second plate 120′. The barrier ribs 133 may be made of chromium or a chromium compound, but the present invention is not limited thereto. For example, the liquid crystals 131 containing the red, green, and blue fluorescent substances 132R, 132G, and 132B may be formed between the barrier ribs 133 spaced a predetermined distance apart from each other by inkjet technology according to a fluorescent color. In other words, each area defined by the barrier ribs 133 contains either the red, green, or blue fluorescent substances 132R, 132G, or 132B. At this time, the height of the barrier ribs 133 may be in the range from 1.0 to 10 μm.

As described above, when the liquid crystal layer 130 is divided by the barrier ribs 133, a color filter layer need not be contained in a second plate 120′, as shown in FIG. 7. Generally, the transmittance of light emitted from a backlight unit is adjusted while the light passes through a liquid crystal layer. The light passed through the liquid crystal layer passes through red, green, and blue color pixels of a color filter layer of a second plate to create color images. However, in the exemplary embodiment of the LCD described with respect to FIG. 7, since the liquid crystal layer 130 includes the red, green, and blue fluorescent substances 132R, 132G, and 132B partitioned by the barrier ribs 133, the liquid crystals 131 containing the red, green, and blue fluorescent substances 132R, 132G, and 132B collide with UV light emitted from a backlight unit (not shown), thereby emitting red, green, and blue light. That is, the LCD shown in FIG. 7 can create red, green, and blue colors while UV light passes through the liquid crystal layer 130. Thus, desired colors can be embodied even in the absence of a color filter layer in the second plate 120′. However, when the second plate 120′ further includes a color filter layer, more vivid color images can be created.

The exemplary embodiment of the LCD shown in FIG. 7 includes the liquid crystal layer 130 including the red, green, and blue fluorescent substances 132R, 132G, and 132B partitioned by the barrier ribs 133. Therefore, color images can be created even in a simple structure with no color filter, which makes the LCD thinner and more cost-effective than LCDs containing a color filter. However, it is also within the scope of these embodiments to provide a color filter to the exemplary embodiment of the LCD shown in FIG. 7 to provide an LCD having the capability of producing even more vivid color images.

Hereinafter, yet another exemplary embodiment of an LCD forming a vertical electric field according to the present invention will be described with reference to FIG. 8. The exemplary embodiment of the LCD shown in FIG. 8 is substantially the same as that of the embodiment shown in FIG. 7 except that a polarization film is formed on a surface of a first plate or a second plate opposite to a liquid crystal layer, and thus a detailed description of overlapping portions will be omitted for convenience of illustration.

FIG. 8 is schematic perspective view illustrating still other exemplary embodiments of LCDs according to the present invention. Referring to FIG. 8 illustrating an LCD forming a vertical electric field, the LCD includes a polarization film 150 formed on one of the two outermost surfaces of a display unit displaying an image using light, e.g., on a surface of a first plate 110 opposite to a liquid crystal layer 130. That is, while the liquid crystal layer 130 is formed on an inner surface of the first plate 110, the polarization film 150 may be formed on an outer surface of the first plate 110. As described above, the polarization film 150 polarizes UV light passing through the display unit 100 to maximize a difference in the collision area of liquid crystals 131 with the UV light before and after voltage application, thereby enhancing the contrast ratio of the LCD.

An antireflective layer 160 may be further formed on a surface of a second plate 120′ opposite to the liquid crystal layer 130 to prevent the incidence of light passed through the display unit 100 into the display unit 100. That is, while the liquid crystal layer 130 is formed on an inner surface of the second plate 120′, the antireflective layer 160 may be formed on an outer surface of the second plate 120′.

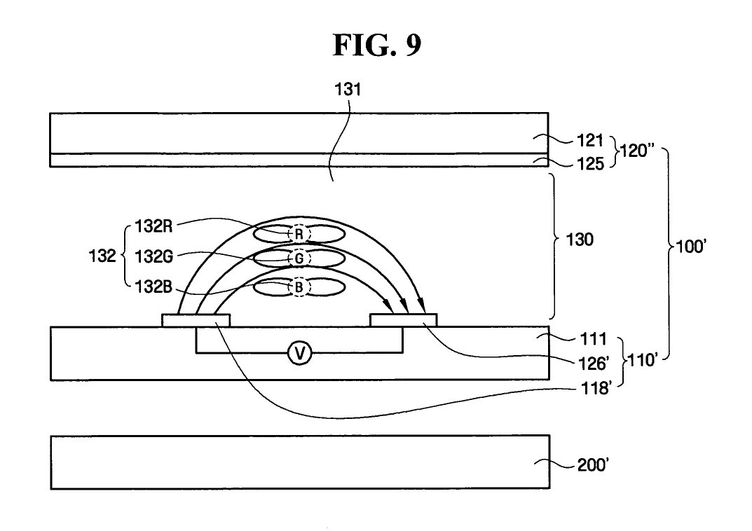

Hereinafter, exemplary embodiments of LCDs forming a horizontal electric field according to the present invention will be described more fully with reference to FIGS. 9 through 14.

FIG. 9 is a schematic sectional view illustrating yet another exemplary embodiment of an LCD according to the present invention.

Referring to FIG. 9 illustrating an exemplary embodiment of an LCD forming a horizontal electric field, the LCD includes a display unit 100′ displaying an image using light and a backlight unit 200′ supplying light to the display unit 100′.

The display unit 100′ includes a first plate 110′ including TFTs (see T of FIG. 1), a second plate 120″ oppositely joined to the first plate 110′, a liquid crystal layer 130 interposed between the first plate 110′ and the second plate 120″ and having liquid crystals 131 and fluorescent substances 132, and a sealant (see 140 of FIG. 1) joining the first plate 110′ and the second plate 120″ and enclosing the liquid crystal layer 130 therein. The exemplary embodiment of the LCD shown in FIG. 9 is different from the exemplary embodiment of the LCD shown in FIG. 1 in that a pixel electrode 118′ and a common electrode 126′ are formed on the same plate, and may lie in a same layer of the LCD. Thus, a detailed description of overlapping portions will be omitted for convenience of illustration.

The first plate 110′ of the display unit 100′ includes a transparent substrate 111, such as made of glass or plastic, and an array layer (not shown) formed on the transparent substrate 111 and having a matrix-type array of TFTs used as switching devices. A drain electrode (not shown) of each TFT is connected to the pixel electrode 118′, and the common electrode 126′ is separated from the pixel electrode 118′ by a predetermined distance. The first plate 110′ may include a plurality of such pixel electrodes 118′ and common electrodes 126′ thereon. The pixel electrodes 118′ and the common electrodes 126′ may extend substantially parallel to each other on a surface of the first plate 110′, and may be formed alternately upon the surface of the first plate 110′.

As described above, since the pixel electrode 118′ and the common electrode 126′ of the display unit 100′ are formed on the same plate, the orientation of the liquid crystals 131 and the fluorescent substances 132 are changed by the horizontal electric field formed between the pixel electrode 118′ and the common electrode 126′ as will be further described below. The second plate 120″ has substantially the same structure as the second plate 120 of the exemplary embodiment of the LCD shown in FIG. 1 except that no common electrode is included in the second plate 120″.

Meanwhile, the liquid crystal layer 130 interposed between the first plate 110′ and the second plate 120″ includes the liquid crystals 131 and the fluorescent substances 132.

In this embodiment, gray scale control is possible by changing the orientation of the liquid crystals 131 according to the horizontal electric field formed between the pixel electrode 118′ and the common electrode 126′ formed on the same plate. Thus, the liquid crystals 131 may be horizontal mode liquid crystals in which, in a voltage-off state, the major axes of the liquid crystals 131 are horizontally directed.

In the liquid crystal layer 130, the liquid crystals 131 may be mixed or combined with the fluorescent substances 132 composed of red, green, and blue fluorescent substances 132R, 132B, and 132G. The behavior of the liquid crystals 131 and the fluorescent substances 132 in the liquid crystal layer 130 in connection with gray scale control according to voltage application will be further described below. For example, when the fluorescent substances 132 are mixed with the liquid crystals 131, the fluorescent substances 132 are aligned in substantially the same direction as the major axes of the liquid crystals 131 along the direction of electric field, i.e., along a horizontal electric field, because they have substantially the same anisotropy as the liquid crystals 131. When the fluorescent substances 132 are combined with the liquid crystals 131, the fluorescent substances 132 are aligned together with the liquid crystals 131 in the same direction as the major axes of the liquid crystals 131 along a horizontal electric field.

The sealant may be the same as the sealant 140 of the LCD according to the embodiment shown in FIG. 1.

The exemplary embodiment of the LCD shown in FIG. 9 is also different from the exemplary embodiment of the LCD shown in FIG. 1 in that a light source of the backlight unit 200′ is a polarized UV light source, as will be further described below. The backlight unit 200′ may include the same reflective sheet, diffusion sheet, and light guide plate as in the backlight unit 200 of the exemplary embodiment of the LCD shown in FIG. 1.

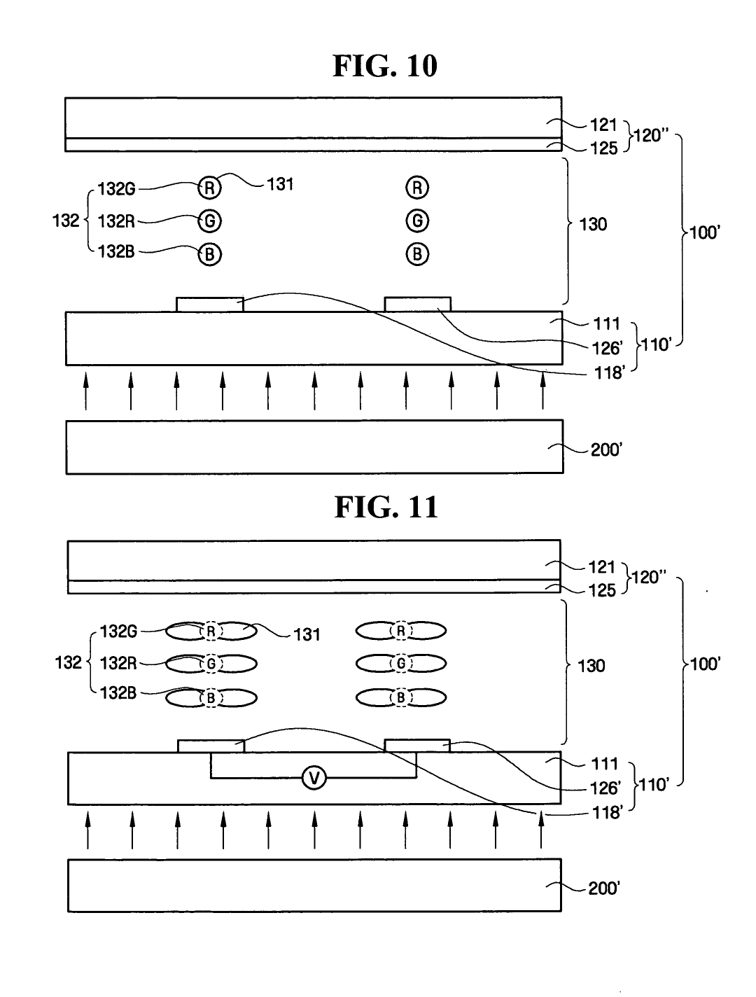

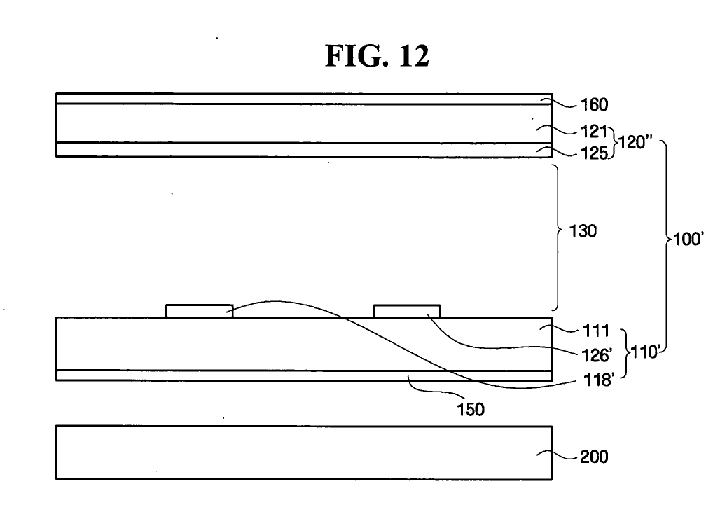

Hereinafter, an exemplary operation of the exemplary embodiment of the LCD shown in FIG. 9 will be described with reference to FIGS. 10 and 11.

FIG. 10 schematically illustrates an exemplary operation of the exemplary embodiment of the LCD shown in FIG. 9 in a voltage-off state and FIG. 11 schematically illustrates an exemplary operation of the exemplary embodiment of the LCD shown in FIG. 9 in a voltage-on state. For convenience of illustration, an exemplary operation of an LCD in which liquid crystals horizontally oriented in a voltage-off state are combined with red, green, and blue fluorescent substances and the polarization direction of light emitted from a polarized UV light source of a backlight unit is perpendicular to the orientation of the major axes of the liquid crystals will be described. However, the present invention is not limited thereto.

First, an exemplary operation of an exemplary embodiment of an LCD in a voltage-off state will be described.

Referring to FIG. 10, polarized UV light emitted from a backlight unit 200′ including a polarized UV light source passes through a display unit 100′ in a perpendicular direction to a first plate 110′ and a second plate 120″ of the display unit 100′. At this time, the major axes of liquid crystals 131 of a liquid crystal layer 130 are oriented perpendicularly to the polarization direction of the polarized UV light passing through the display unit 100′. The major axes of fluorescent substances 132 composed of red, green, and blue fluorescent substances 132R, 132G, and 132B in combination with the liquid crystals 131 are also oriented perpendicularly to the polarization direction of the polarized UV light passing through the display unit 100′. Thus, the polarization direction of the polarized UV light passing through the display unit 100′ is perpendicular to the orientation of the red, green, and blue fluorescent substances 132R, 132G, and 132B. Therefore, the fluorescent substances 132 substantially hardly collide with the polarized UV light, thereby leading to a black mode of the LCD.

Next, an exemplary operation of an exemplary embodiment of an LCD in a voltage-on state will be described.

Referring to FIG. 11, a voltage is applied to a pixel electrode 118′ and a common electrode 126′ formed on a first plate 110′ including TFTs so that a sufficient voltage above a critical voltage is applied to a liquid crystal layer 130. FIG. 11 illustrates the case where, in a voltage-on state, the major axes of liquid crystals 131 are oriented substantially parallel to a horizontal electric field. At this time, fluorescent substances 132 composed of red, green, and blue fluorescent substances 132R, 132G, and 132B in combination with the liquid crystals 131 are also oriented substantially parallel to the polarization direction of polarized UV light. Therefore, polarized UV light emitted from a backlight unit 200′ collides with the red, green, and blue fluorescent substances 132R, 132G, and 132B oriented substantially parallel to the polarization direction of the polarized UV light. In this case, a collision area of the fluorescent substances 132 with the polarized UV light is relatively increased, thereby emitting much visible light, as compared to when the major axes of the fluorescent substances 132 are oriented in a substantially perpendicular direction to the polarization direction of the polarized UV light, as previously described with respect to FIG. 10. Voltage application to the liquid crystal layer 130 as shown in FIG. 11 gives rise to a white mode of an LCD. Thus, adjustment of the voltage difference between the pixel electrode 118′ and the common electrode 126′ enables gray scale control.

The exemplary embodiments of the LCD shown in FIGS. 9-10 employ a backlight unit 200′ having a polarized UV light source. If a common UV light source, i.e., an unpolarized UV light source is used in the backlight unit 200′ of the LCD in which the pixel electrode 118′ and the common electrode 126′ are formed on the same plate, the above-described gray scale control would be impossible. That is, if a common UV light source is used in an LCD as shown in FIG. 9 in which liquid crystals having a horizontal mode in a voltage-off state are mixed or combined with fluorescent substances, a collision area of the fluorescent substances with UV light increases, thereby causing the emission of large quantity of light from a liquid crystal layer. Furthermore, since the orientation of the liquid crystals is changed on the same plane along a horizontal electric field formed in a voltage-on state, the fluorescent substances mixed or combined with the liquid crystals are also oriented in substantially the same direction as the liquid crystals. Therefore, a collision area of the fluorescent substances with the UV light increases, thereby emitting much light. For this reason, gray scale control according to a voltage-on/off state is impossible. Thus, the backlight unit 200′ of FIGS. 9-11 uses a polarized UV light source.

As described above, grayscale-calibrated light beams create desired color images while passing through the second plate 120″. That is, red, green, and blue color pixels formed in a color filter layer 125 of the second plate 120″ allow only red, green, and blue light beams to pass therethrough according to the characteristics of the color pixels, thereby creating color images that can be perceived by a viewer.

As previously described, the exemplary embodiment of the LCD shown in FIG. 9 uses a polarized UV light source. Thus, even when the liquid crystal layer 130 of the LCD according to the embodiment shown in FIG. 1 is used, gray scale control can be accomplished by changing the orientation of liquid crystals and fluorescent substances according to a voltage-on/off state. Therefore, no polarization films are separately required at the outermost sides of a display unit, thereby preventing reduction in transmittance and viewing angle due to a polarization film.

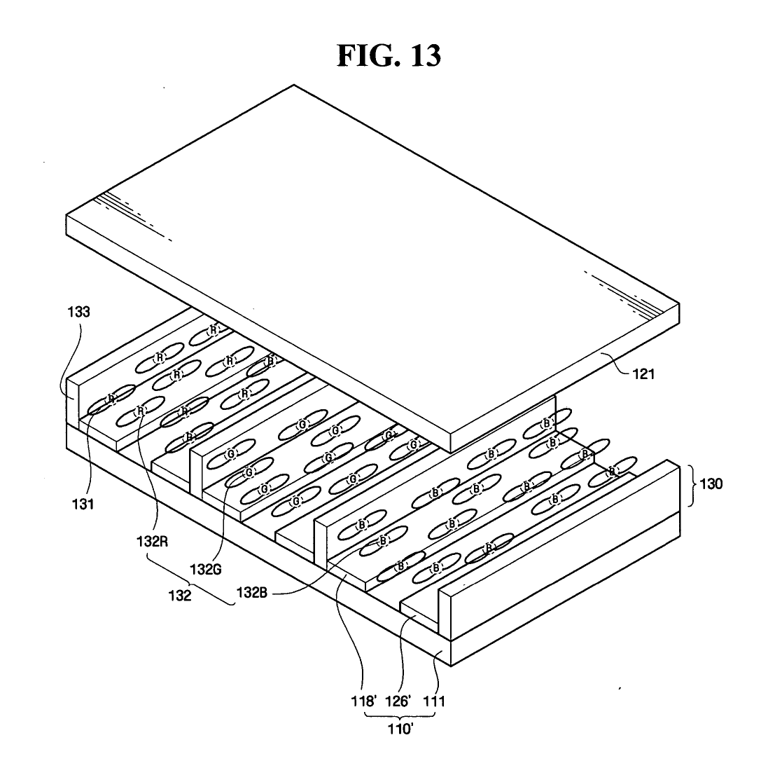

Hereinafter, another exemplary embodiment of an LCD forming a horizontal electric field according to the present invention will be described with reference to FIG. 12. The exemplary embodiment of the LCD shown in FIG. 12 is substantially the same as that according to the exemplary embodiment of the LCD shown in FIG. 9 except that a polarization film is formed on a surface of a first plate or a second plate opposite to a liquid crystal layer. Thus, a detailed description of overlapping portions will be omitted for convenience of illustration.

FIG. 12 is a schematic sectional view illustrating a further exemplary embodiment of an LCD according to the present invention.

Referring to FIG. 12 illustrating another exemplary embodiment of an LCD forming a horizontal electric field, the LCD includes a polarization film 150 formed on one of the two outermost surfaces of a display unit 100′ displaying an image using light, e.g., on a surface of a first plate 110′ opposite to a liquid crystal layer 130. That is, while the liquid crystal layer 130 is formed on an inner surface of the first plate 110′, the polarization film 150 may be formed on an outer surface of the first plate 110′.

The polarization film 150 is used to enhance a contrast ratio of the LCD. That is, the polarization film 150 can polarize UV light in a perpendicular direction to the orientation of the major axes of fluorescent substances 132 of the liquid crystal layer 130 in a voltage-off state. Therefore, the collision area of the fluorescent substances 132 with the UV light is minimized, thereby decreasing a black brightness of the LCD. Accordingly, the contrast ratio before and after voltage application can be enhanced.

An antireflective layer 160 may be further formed on a surface of a second plate 120″ opposite to the liquid crystal layer 130 to prevent the incidence of light passed through the display unit 100′ back into the display unit 100′. That is, while the liquid crystal layer 130 is formed on an inner surface of the second plate 120″, the antireflective layer 160 may be formed on an outer surface of the second plate 120″.

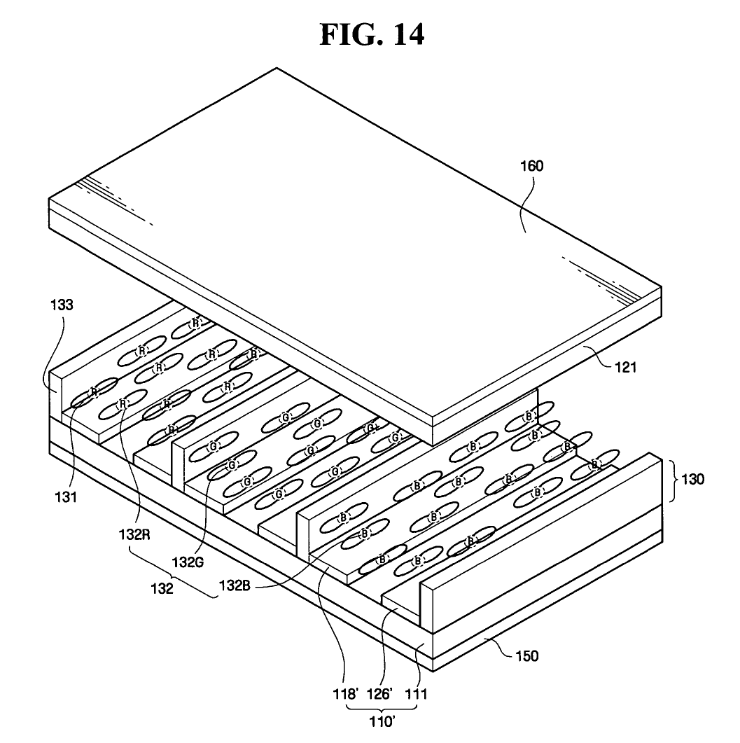

Hereinafter, still another exemplary embodiment of an LCD forming a horizontal electric field according to the present invention will be described with reference to FIG. 13. The exemplary embodiment of the LCD shown in FIG. 13 is substantially the same as that of the exemplary embodiment of the LCD shown in FIG. 9 except that red, green, and blue fluorescent substances of a liquid crystal layer are partitioned by barrier ribs, and thus a detailed description of overlapping portions will be omitted for convenience of illustration.

FIG. 13 is a schematic perspective view illustrating another exemplary embodiment of an LCD according to the present invention.

Referring to FIG. 13, in a liquid crystal layer 130 constituting a display unit of an LCD, liquid crystals 131 containing red fluorescent substances 132R, liquid crystals 131 containing green fluorescent substances 132G, and liquid crystals 131 containing blue fluorescent substances 132B are partitioned by barrier ribs 133 in such a way to correspond to respective pixel areas. In other words, each area defined by the barrier ribs 133 contains either the red, green, or blue fluorescent substances 132R, 132G, or 132B. At this time, the liquid crystals 131 and the red, green, and blue fluorescent substances 132R, 132G, and 132B contained in the liquid crystal layer 130 may be in a mixed state or in a combined state.

The barrier ribs 133 may be spaced a predetermined distance apart from each other and are positioned between the first plate 110′ and the second plate 120″. The barrier ribs 133 may be made of chromium or a chromium compound, but the present invention is not limited thereto. For example, the liquid crystals 131 containing the red, green, and blue fluorescent substances 132R, 132G, and 132B may be formed between the barrier ribs 133 spaced a predetermined distance apart from each other by inkjet technology according to a phosphor color. At this time, the height of the barrier ribs 133 may be in the range from 1.0 to 10 □.

As described above, when the liquid crystal layer 130 is divided by the barrier ribs 133, a color filter layer need not be contained in a second plate because the red, green, and blue fluorescent substances 132R, 132G, and 132B contained in the liquid crystals 131 emit red, green, and blue light when the liquid crystals 131 collide with UV light emitted from a backlight unit (not shown). That is, the LCD shown in FIG. 13 can create red, green, and blue colors while UV light passes through the liquid crystal layer 130. Thus, desired colors can be embodied even in the absence of a color filter layer. However, when the second plate 120″ further includes a color filter layer, more vivid color images can be created.

The exemplary embodiment of the LCD shown in FIG. 13 includes the liquid crystal layer 130 including the red, green, and blue fluorescent substances 132R, 132G, and 132B partitioned by the barrier ribs 133. Therefore, color images can be created even in a simple structure with no color filter, which makes the LCD thinner and more cost-effective than LCDs containing a color filter. However, it is also within the scope of these embodiments to provide a color filter to the exemplary embodiment of the LCD shown in FIG. 13 to provide an LCD having the capability of producing even more vivid color images.

Hereinafter, yet another exemplary embodiment of an LCD forming a horizontal electric field according to the present invention will be described with reference to FIG. 14. The exemplary embodiment of the LCD shown in FIG. 14 is substantially the same as that of the exemplary embodiment of the LCD shown in FIG. 13 except that a polarization film is formed on a surface of a first plate or a second plate opposite to a liquid crystal layer and a backlight unit includes a common UV light source, and thus a detailed description of overlapping portions will be omitted for convenience of illustration.

FIG. 14 is a schematic perspective view illustrating other exemplary embodiments of LCDs according to the present invention.

Referring to FIG. 14 illustrating yet another exemplary embodiment of an LCD forming a horizontal electric field, the LCD includes a polarization film 150 formed on one of the two outermost surfaces of a display unit displaying an image using light, e.g., on a surface of a first plate 110′ opposite to a liquid crystal layer 130. That is, while the liquid crystal layer 130 is formed on an inner surface of the first plate 110′, the polarization film 150 may be formed on an outer surface of the first plate 110′. As described above, the polarization film 150 polarizes UV light passing through the display unit 100′ to maximize a difference in the collision area of liquid crystals 131 with UV light before and after voltage application, thereby enhancing the contrast ratio of the LCD.

As described above, the LCD of the present invention provides at least the following advantages.

First, gray scale control is possible even without a polarization film. Furthermore, the liquid crystals including the fluorescent substances can be used both in a vertical electric field type LCD and a horizontal electric field type LCD.

Second, since the LCD has no polarization film or only one polarization film, reduction in transmittance and viewing angle due to the presence of a polarization film or films can be solved.

Third, since the liquid crystal layer can be divided by a barrier rib, the use of a color filter layer may not be required, thus providing a thinner and more cost effective LCD.

Fourth, enhancements in transmittance and viewing angle, together with a simple structure, lead to no additional increase in manufacturing costs and power consumption in the LCD.

It will be understood by those of ordinary skill in the art that various changes in form and details may be made therein without departing from the spirit and scope of the present invention as defined by the following claims. Therefore, it is to be appreciated that the above described exemplary embodiments embodiment is are for purposes of illustration only and not to be construed as a limitation of the invention. The scope of the invention is given by the appended claims, rather than the preceding description, and all variations and equivalents which fall within the range of the claims are intended to be embraced therein.

What is claimed is:

1. A liquid crystal display comprising:
a backlight unit including a light source emitting ultraviolet light; and
a display unit including a first plate having a plurality of pixel electrodes, a second plate opposite to the first plate and having a common electrode forming a vertical electric field through its interaction with the pixel electrodes, and a liquid crystal layer interposed between the first plate and the second plate and having fluorescent substances absorbing the ultraviolet light emitted from the backlight unit and emitting red, green, or blue light.

2. The liquid crystal display of claim 1, wherein the fluorescent substances include red fluorescent substances, green fluorescent substances, and blue fluorescent substances.

3. The liquid crystal display of claim 1, wherein the fluorescent substances are combined with liquid crystals forming the liquid crystal layer.

4. The liquid crystal display of claim 1, wherein the fluorescent substances are mixed with liquid crystals forming the liquid crystal layer.

5. The liquid crystal display of claim 1, wherein the second plate comprises a color filter layer.

6. The liquid crystal display of claim 1, wherein the fluorescent substances have substantially the same anisotropy as liquid crystals forming the liquid crystal layer.

7. The liquid crystal display of claim 1, wherein the liquid crystal layer is partitioned by a barrier rib according to color of the fluorescent substances emitting red, green, or blue light and corresponding to respective pixel areas of the display unit.

8. The liquid crystal display of claim 7, wherein the barrier rib has a height of 1.0 to 10 μm.

9. The liquid crystal display of claim 7, wherein the liquid crystal display does not include a color filter layer and color images are displayed on the display unit using the light emitted from the fluorescent substances.

10. The liquid crystal display of claim 1, wherein a polarization film is further formed on an outer surface of the first plate or the second plate.

11. The liquid crystal display of claim 10, wherein the polarization film polarizes the ultraviolet light parallel to orientation of major axes of the fluorescent substances after forming the vertical electric field.

12. The liquid crystal display of claim 1, wherein an antireflective layer is further formed on an outer surface of the second plate.

13. A liquid crystal display comprising:
a backlight unit including a light source emitting ultraviolet light; and
a display unit including a first plate having a plurality of pixel electrodes and common electrodes formed alternately parallel to each other on the first plate and forming a horizontal electric field through interaction therebetween, a second plate opposite to the first plate, and a liquid crystal layer interposed between the first plate and the second plate and including fluorescent substances absorbing the ultraviolet light emitted from the backlight unit and emitting red, green, or blue light.

14. The liquid crystal display of claim 13, wherein the fluorescent substances include red fluorescent substances, green fluorescent substances, and blue fluorescent substances.

15. The liquid crystal display of claim 13, wherein the ultraviolet light emitted from the light source is polarized ultraviolet light.

16. The liquid crystal display of claim 13, wherein the fluorescent substances are combined with liquid crystals forming the liquid crystal layer.

17. The liquid crystal display of claim 13, wherein the fluorescent substances are mixed with liquid crystals forming the liquid crystal layer.

18. The liquid crystal display of claim 13, wherein the second plate comprises a color filter layer.

19. The liquid crystal display of claim 13, wherein the fluorescent substances have substantially same anisotropy as liquid crystals forming the liquid crystal layer.

20. The liquid crystal display of claim 13, wherein the liquid crystal layer is partitioned by a barrier rib according to color of the fluorescent substances emitting red, green, or blue light and corresponding to respective pixel areas of the display unit.

21. The liquid crystal display of claim 20, wherein the barrier rib has a height of 1.0 to 10 μm.

22. The liquid crystal display of claim 20, wherein the liquid crystal display does not include a color filter layer and color images are displayed on the display unit using the light emitted from the fluorescent substances.

23. The liquid crystal display of claim 13, wherein a polarization film is further formed on an outer surface of the first plate or the second plate.

24. The liquid crystal display of claim 23, wherein the polarization film polarizes the ultraviolet light perpendicular to orientation of major axes of the fluorescent substances after forming the horizontal electric field.

25. A liquid crystal display comprising:
a liquid crystal layer including liquid crystals, first fluorescent substances emitting a first colored light, second fluorescent substances emitting a second colored light differently colored from the first colored light, and third fluorescent substances emitting a third colored light differently colored from the first and second colored lights.

26. The liquid crystal display of claim 25, wherein the first, second, and third fluorescent substances absorb ultraviolet light from a backlight unit and emit visible light.

27. The liquid crystal display of claim 25, wherein the first, second, and third fluorescent substances are alternately arranged according to pixel areas of the liquid crystal display.

28. The liquid crystal display of claim 25, wherein the liquid crystal display displays color images using the first, second, and third colored lights.

29. The liquid crystal display of claim 28, wherein the liquid crystal display does not include a color filter layer.

30. The liquid crystal display of claim 25, wherein gray scale control of the liquid crystal display is enabled by adjusting a voltage difference between a pixel electrode and a common electrode of the liquid crystal display.

31. The liquid crystal display of claim 30, wherein the liquid crystal display does not include a polarization film.

32. The liquid crystal display of claim 30, wherein changing orientation of the liquid crystals and the first, second, and third fluorescent substances according to voltage-on and voltage-off states of the liquid crystal display provides the gray scale control.
